(19) United States
(12) Patent Application Publication
(10) Pub. No.: US 2010/0328598 A1
(43) Pub. Date: Dec. 30, 2010

(54) SEALANT, DISPLAY DEVICE HAVING THE SAME AND METHOD OF MANUFACTURING THE SAME

(76) Inventors: Jun-Hyup LEE, Seoul (KR); Ji-Yoon Jung, Cheonan-si (KR); Jung-Hun Lee, Seoul (KR); Jae-Jin Lyu, Yongin-si (KR); Jeong-Uk Heo, Seongnam-si (KR)

Correspondence Address: F. CHAU & ASSOCIATES, LLC, 130 WOODBURY ROAD, WOODBURY, NY, 11797, US

(21) Appl. No.: 12/703,913

(22) Filed: Feb. 11, 2010

(30) Foreign Application Priority Data
Jun. 24, 2009 (KR) 2009-0056268

(51) Int. Cl. G02F 1/1339; H01J 9/20; C08F 2/46

(52) U.S. Cl. 349/153; 445/25; 522/39; 522/63; 522/38

(57) ABSTRACT

A sealant for a display device includes a photoinitiator having an oxime ester compound or a 2,4,6-trimethylbenzoyl-diphenyl-phosphineoxide compound, and a curing resin. The sealant may further include a curing agent, a coupling agent, and a filler. A display device includes a first substrate having a display area, a second substrate opposite to the first substrate, a liquid crystal layer interposed between the first substrate and the second substrate, and a sealing pattern contacting the first substrate and the second substrate so as substrate to combine the first substrate and the second substrate with each other. The sealing pattern may include a photoinitiator having an oxime ester compound or a 2,4,6-trimethylbenzoyl-diphenyl-phosphineoxide compound. In a method of manufacturing the display device, a sealant including a photoinitiator having an oxime ester compound or a 2,4,6-trimethylbenzoyl-diphenyl-phosphineoxide compound, and a curing resin is coated along a peripheral portion of the first substrate to form a sealing pattern. A liquid crystal is dropped on the first substrate. The second substrate opposite to the first substrate is disposed on the first substrate. The sealing pattern is cured to combine the first substrate and the second substrate with each other.

### CROSS-REFERENCE TO RELATED APPLICATION

This application claims priority to Korean Patent Application No. 2009-56268, filed on Jun. 24, 2009, the disclosure of which is hereby incorporated by reference herein in it's entirety.

### BACKGROUND OF THE INVENTION

1. Technical Field

Example embodiments of the present invention relate to a sealant, a display device having the sealant, and to a method of manufacturing the display device. More particularly, example embodiments of the present invention relate to a sealant capable of displaying an image of high quality, a display device having the sealant, and to a method of manufacturing the display device.

2. Description of the Related Art

Generally, a display device includes a liquid crystal display device, a plasma display, an organic electroluminescence display, and the like. These display devices are applicable to display an image, in devices such as, for example, a television set, a monitor of a laptop computer, and a cellular phone.

The display device may include two substrates facing each other. For example, the liquid crystal display device may include two substrates facing each other and a liquid crystal layer interposed therebetween. An electric field may be applied to the liquid crystal layer, so that the alignment of liquid crystal may be changed to display an image.

A region where the image is displayed is defined as a display area. The display area may be positioned at a center portion excluding a peripheral portion of the two substrates. A sealing pattern is formed on the peripheral portion to combine the two substrates together.

The sealing pattern may be formed of a sealant having various compounds. The compounds may affect the alignment of the liquid crystal, so that a quality of an image may be deteriorated on a corresponding area.

### SUMMARY OF THE INVENTION

Example embodiments of the present invention may provide a sealant capable of improving an image quality, a display device having the sealant, and a method of manufacturing the display device.

According to one aspect of the present invention, a sealant includes a photoinitiator having an oxime ester compound, and a curing resin.

In an example embodiment of the present invention, the oxime ester compound may further include one functional group selected from the group consisting of 4-acetyldiphenyl sulfide, N-ethylcarbazole, and 2′-methylphenonyl N-ethylcarbazole.

In an example embodiment of the present invention, the oxime ester compound may further include alkyl group having 1 to 12 carbon atoms.

In an example embodiment of the present invention, the oxime ester compound may further include one functional group selected from the group consisting of phenyl group and alkyl group having 1 to 12 carbon atoms.

In an example embodiment of the present invention, the photoinitiator may have a molecular weight more than 350.

In an example embodiment, a sealant for a display device is provided. The sealant includes a photoinitiator including an oxime ester compound represented by the following Chemical Formula 2 and a curing resin.

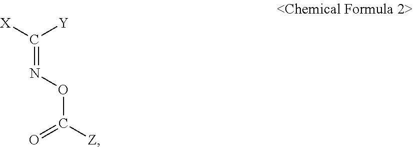

wherein X of the photoinitiator compound includes one selected from the group consisting of functional groups represented by the following Chemical Formulas 3 to 5.

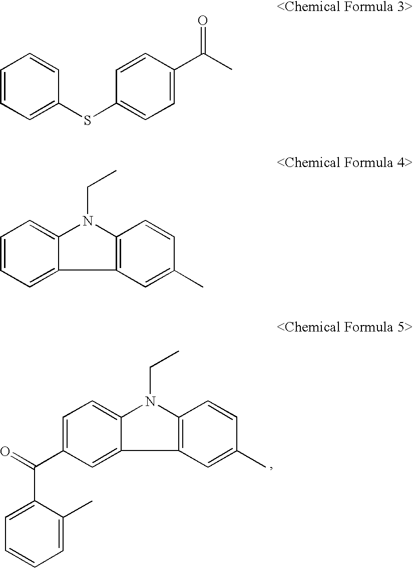

wherein Y of the photoinitiator compound includes a functional group represented by the following Chemical Formula 6,

CₙH₂ₙ₊₁, <Chemical Formula 6>

wherein n represents an integer in the range of 1 to 12,

wherein Z of the photoinitiator compound includes one selected from the group consisting of functional groups represented by the following Chemical Formulas 7 and 8.

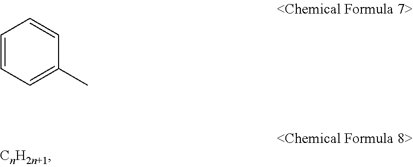

and wherein n represents an integer in the range of 1 to 12.

In accordance with an example embodiment of the present invention, a sealant for a display device is provided. The sealant includes a photoinitiator including a compound represented by the following Chemical Formula 9 and a curing resin.

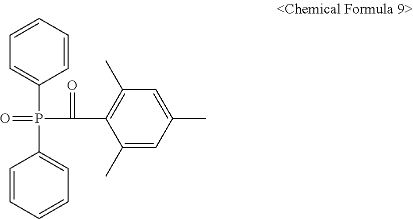

In accordance with example embodiment of the present invention, a display device is provided. The display device includes a first substrate having a display area, a second substrate opposite to the first substrate, a liquid crystal layer interposed between the first substrate and the second substrate, and a sealing pattern contacting the first substrate and the second substrate so as to combine the first substrate and the second substrate with each other. The sealing pattern includes the photoinitiator including the oxime ester compound represented by Chemical Formula 2.

In accordance with example embodiment of the present invention, a display device is provided. The display device includes a first substrate having a display area, a second substrate opposite to the first substrate, a liquid crystal layer interposed between the first substrate and the second substrate, and a sealing pattern contacting the first substrate and the second substrate so as to combine the first substrate and the second substrate with each other. The sealing pattern includes the photoinitiator including the compound represented by Chemical Formula 9.

In accordance with another example embodiment of the present invention, a method of manufacturing a display device is provided. In the method, a sealant including a photoinitiator including an oxime ester compound represented by Chemical Formula 2 and a curing resin is coated along a peripheral portion of the first substrate to form a sealing pattern. A liquid crystal is dropped on the first substrate. The second substrate opposite to the first substrate is disposed on the first substrate. The sealing pattern is cured to combine the first substrate and the second substrate with each other.

In accordance with another example embodiment of the present invention, a method of manufacturing a display device is provided. In the method, a sealant including a photoinitiator including a compound represented by Chemical Formula 9 and a curing resin is coated along a peripheral portion of the first substrate to form a sealing pattern. A liquid crystal is dropped on the first substrate. The second substrate opposite to the first substrate is disposed on the first substrate. The sealing pattern is cured to combine the first substrate and the second substrate with each other.

According to some example embodiments of the present invention, a compound of a sealant may affect an alignment of a liquid crystal, so that a quality of image may be prevented from being deteriorated on area having the compound.

### BRIEF DESCRIPTION OF THE DRAWINGS

Example embodiments of the present invention can be understood in more detail from the following description taken in conjunction with the accompanying drawings, in which:

FIG. 1 is an exploded perspective view illustrating a display device according to an example embodiment of the present invention;

FIG. 2 is a cross-sectional view illustrating a boundary portion of a display area of the display device shown in FIG. 1;

FIGS. 3 to 7 are perspective views illustrating a method of manufacturing the display device shown in FIG. 1;

FIG. 8 is a perspective view illustrating a display device according to an example embodiment of the present invention; and

FIG. 9 is a cross-sectional view illustrating a boundary portion of a display area of the display device shown in FIG. 8.

### DETAILED DESCRIPTION OF THE EXAMPLE EMBODIMENTS OF THE INVENTION

The present invention is described more fully hereinafter with reference to the accompanying drawings, in which example embodiments of the present invention are shown. The present invention may, however, be embodied in many different forms and should not be construed as limited to the example embodiments set forth herein. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments of the invention are described herein with reference to cross-sectional illustrations that are schematic illustrations of idealized example embodiments (and intermediate structures) of the present invention. As such, variations from the shapes of the illustrations as a result, for example, of manufacturing techniques and/or tolerances, are to be expected. Thus, example embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments of the present invention will be explained in detail with reference to the accompanying drawings.

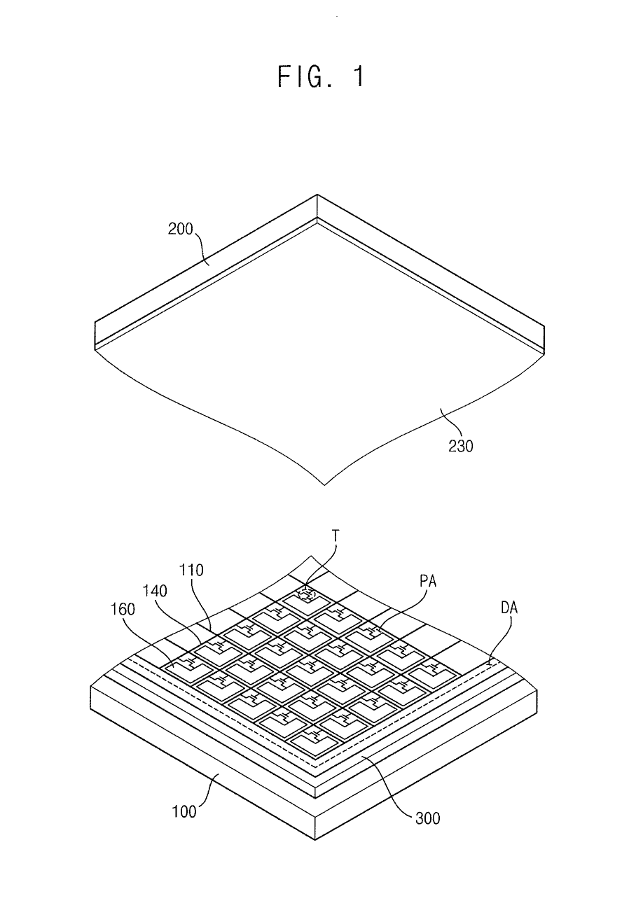

FIG. 1 is an exploded perspective view illustrating a display device according to an example embodiment of the present invention.

Referring to FIG. 1, the display device includes a first substrate 100, a second substrate 200, and a liquid crystal layer 400 interposed between the first substrate 100 and second substrate 200. A display area DA displaying an image is defined on the first substrate 100. The display area DA includes a center portion of the first substrate 100 excluding a peripheral portion of the first substrate 100.

In an outer area of the display area DA, a sealing pattern 300 is formed along the peripheral portion of the first substrate 100 to combine the first substrate 100 and the second substrate 200. Alternatively, the sealing pattern 300 may be formed on the second substrate 200 corresponding to the outer area of the display area DA.

A plurality of gate lines 110 and data lines 140 are formed on the first substrate 100 in the display area DA. The gate lines 110 and the data lines 140 cross each other to define a plurality of pixel areas PA. The pixel areas PA represent a smallest unit displaying an image. Each of the pixel areas PA includes a pixel electrode 160 and a thin-film transistor T.

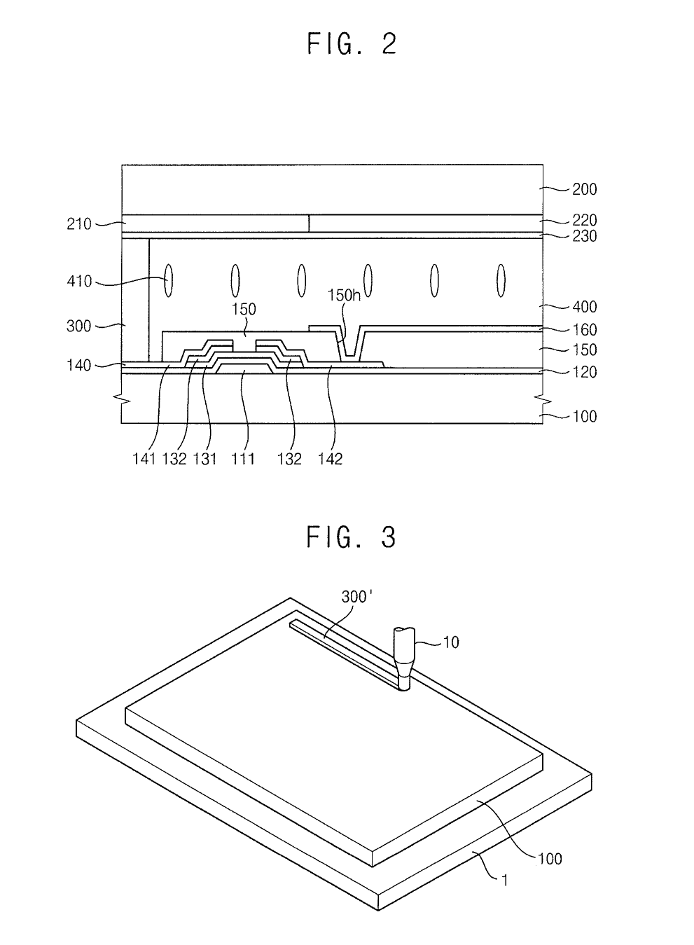

FIG. 2 is a cross-sectional view illustrating a boundary portion of a display area of the display device shown in FIG. 1.

Referring to FIG. 2, the first and the second substrates 100 and 200 are combined by the sealing pattern 300 such that the first and the second substrates 100 and 200 are spaced apart from each other by a predetermined distance. The liquid crystal layer 400 including a liquid crystal 410 is disposed between the first and second substrates 100 and 200. A gate electrode 111 branching from a gate line 110 is formed on the first substrate 100. A gate insulating layer 120 is formed on the gate electrode 111 to cover the substantially entire surface of the first substrate 100. A semiconductor pattern 131 is formed on the gate insulating layer 120 overlapping with the gate electrode 111. The semiconductor pattern 131 may be formed from an intrinsic semiconductor, and may have an integrally formed structure. Furthermore, an ohmic contact pattern 132 may be formed on the semiconductor pattern 131. The ohmic contact pattern 132 may include impurities. The ohmic contact pattern 132 may be divided into two separated parts. A source electrode 141 and a drain electrode 142 are formed on the ohmic contact pattern 132 having the separated parts, respectively, and face each other. The source electrode 141 is connected to a data line 140.

The thin-film transistor T includes the gate electrode 111, the semiconductor pattern 131, the source electrode 141 and the drain electrode 142. A passivation layer 150 having a contact hole 150h formed therethrough is formed on the thin-film transistor T. A pixel electrode 160 is formed on the passivation layer 150, and is electrically connected to the drain electrode 142 through the contact hole 150h.

A light blocking pattern 210 is formed on the second substrate 220, and a portion of the light blocking pattern 210 corresponding to the pixel area OA is removed to form an opening. A color filter 220 is formed on the second substrate 200, and fills the opening corresponding to the pixel area OA. The light blocking pattern 210 blocks light on a boundary region of the pixel area PA. The color filter 220 serves to display a color of an image. A common electrode 230 facing the pixel electrode 160 is formed on the light blocking pattern 210 and the color filter 220. Alternatively, the color filter 220, the light blocking pattern 210, and the common electrode 230 may be formed on the first substrate 100.

Hereinafter, processes of operating the display device of example embodiments of the present invention will be described.

Referring to FIGS. 1 and 2, a gate signal is applied to the gate line 110 to turn on the thin-film transistor T. A data signal according to image information is transmitted to the data line 140, so that a data voltage corresponding to the data signal is applied to the pixel electrode 160. A common voltage is applied to the common electrode 230. Due to the voltage difference between the pixel electrode 160 and the common electrode 230, an electric field is applied to the liquid crystal layer 400. The liquid crystal 410 has an anisotropy of permittivity, so that an alignment of the liquid crystal 410 may be changed in response to the electric field. The liquid crystal 410 has an anisotropy of reflective index, so that a light transmittance of the liquid crystal varies according to the alignment of the liquid crystal. An alignment of the liquid crystal 410 may be controlled by changing the intensity and the direction of the electric field. As a result, an image may be displayed by the light passing through the liquid crystal layer 400.

According to the display device, an image may be displayed by light passing through the liquid crystal 410. Therefore, when a liquid crystal 410 is contaminated, the quality of an image may be deteriorated. The liquid crystal 410 may be contaminated by the sealing pattern 300. The sealing pattern 300 includes a compound for combining the first and second substrates 100 and 200. Components included in the compound may diffuse into the liquid crystal layer 400, and may contaminate the liquid crystal 410.

The sealing pattern 300 according to example embodiments of the present embodiment includes a sealant having compositions described below to reduce contamination of the liquid crystal 410. The sealant includes, for example, a curing resin, a curing agent, a photoinitiator, a coupling agent, and a filler.

The curing resin includes a photo curable resin cured by light such as, for example, ultra-violet (UV) light, and a heat curable resin cured by heat. For example, the curing resin includes an acrylic compound and an epoxy-based compound. The acrylic compound is generally cured by light, and the epoxy compound is generally cured by heat.

The curing agent fills a space between particles of the sealant to increase the strength of the sealant. Examples of the curing agent may include, but are not limited to silica, silicon carbide, silicon nitride, boron nitride, calcium carbonate, magnesium carbonate, calcium silicate, aluminum silicate, glass fiber.

Light is irradiated into the photoinitiator to generate an active radical. Then, a polymerization is caused to form the curing resin. The photoinitiator includes a compound represented by, for example, the following Chemical Formula 2 including a compound represented by the following Chemical Formula 1.

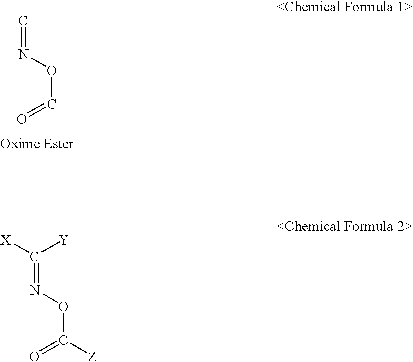

For example, in an example embodiment, the photoinitiator may include an oxime ester compound at a center, X including one selected from the group consisting of functional groups represented by the following Chemical Formulas 3 to 5, Y including a compound represented by the following Chemical Formula 6, and Z one selected from the group consisting of functional groups represented by the following Chemical Formulas 7 and 8.

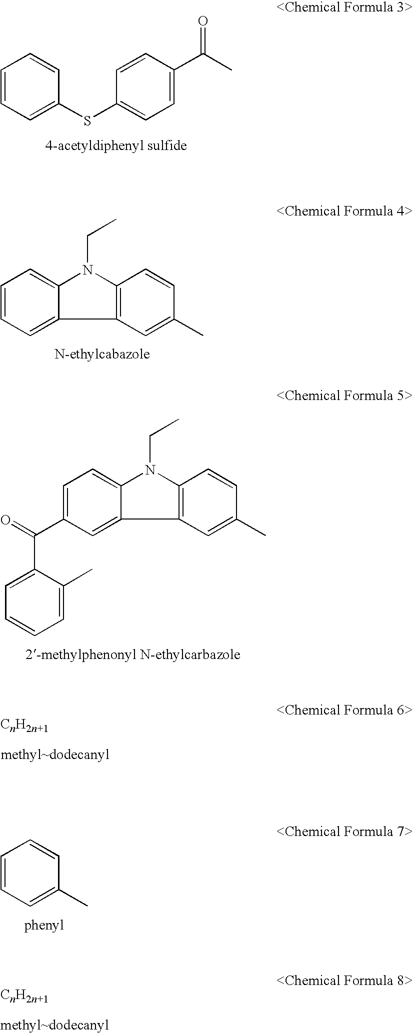

In the Chemical Formulas 6 and 8, n represents an integer in the range of 1 to 12.

In another example embodiment, the photoinitiator may include, for example, a compound represented by the following Chemical Formula 9.

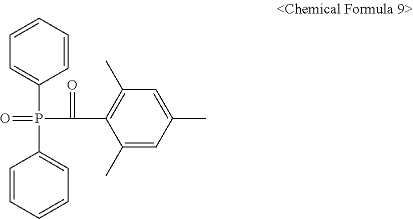

2,4,6-trimethylbenzoyl-diphenyl-phosphineoxide

The photoinitiator of example embodiments of the present invention has a maximum absorption coefficient at a wavelength of about 365 nm that is a center wavelength of light used for photo-curing the sealant to reduce contamination of the liquid crystal 410 by the photoinitiator that is not cured. In addition, the photoinitiator has a molecular weight more than 350, so that elution of the photoinitiator into the liquid crystal layer 400 may be difficult. Thus, contamination of the liquid crystal 410 may be reduced.

The coupling agent may increase the adhesive ability of the sealant. Examples of the coupling agent may include but are not limited to a silane compound, for example, 3-glycidoxypropyl trimethoxy silane, 3-glycidoxypropyl methyl dimethoxy silane, 3-methacryloxypropyl trimethoxy silane, 3-chloropropyl methyl dimethoxy silane, and 3-chloropropyl trimethoxy silane.

The filler fills a space between particles of the sealant to increase strength the sealant. Examples of the filler may include but are not limited to silica, silicon carbide, silicon nitride, boron nitride, calcium carbonate, magnesium carbonate, calcium silicate, aluminum silicate, glass fiber.

The sealant may include, for example, about 55 percent by weight to about 65 percent by weight of the curing resin, about 3 percent by weight to about 4 percent by weight of the curing agent, about 0.5 percent by weight to about 2 percent by weight of the photoinitiator, about 0.5 percent by weight to about 2 percent by weight of the coupling agent, about 20 percent by weight to about 30 percent by weight of the filler.

Hereinafter, a method of manufacturing the display device by using the sealant according to an example embodiment the present invention will be described.

FIGS. 3 to 7 are perspective views illustrating a method of manufacturing the display device shown in FIG. 1.

Referring to FIG. 3, the substrate 100 is disposed on a stage 1. A first dispenser 10 is disposed on the first substrate 100 such that the first dispenser 10 and the first substrate 100 are spaced apart from each other. The first dispenser 10 is provided with a sealant 300′ from a feeder, and is moved along the first substrate 100 to provide the sealant 300′ to the first substrate 100. The sealant 300′ includes a curing resin, a curing agent, a photoinitiator, a coupling agent, and a filler. The photoinitiator, in this example embodiment includes, for example, an oxime ester compound represented by the Chemical Formula 2 set forth above.

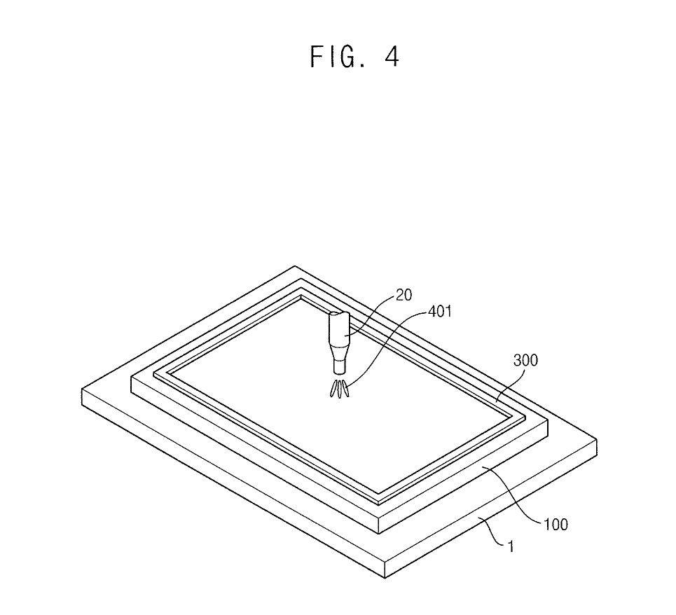

Referring to FIG. 4, the sealing pattern 300 is formed by the sealant 300′ provided along the peripheral portion of the first substrate 100. The second dispenser 20 is disposed on the first substrate 100 such that the second dispenser 20 and the first substrate 100 are spaced apart from each other. The second dispenser 20 is provided with a liquid crystal 410 from a feeder, and provides the liquid crystal 410 to the first substrate 100. The liquid crystal 410 is injected into an inner area surrounded by the sealing pattern 300.

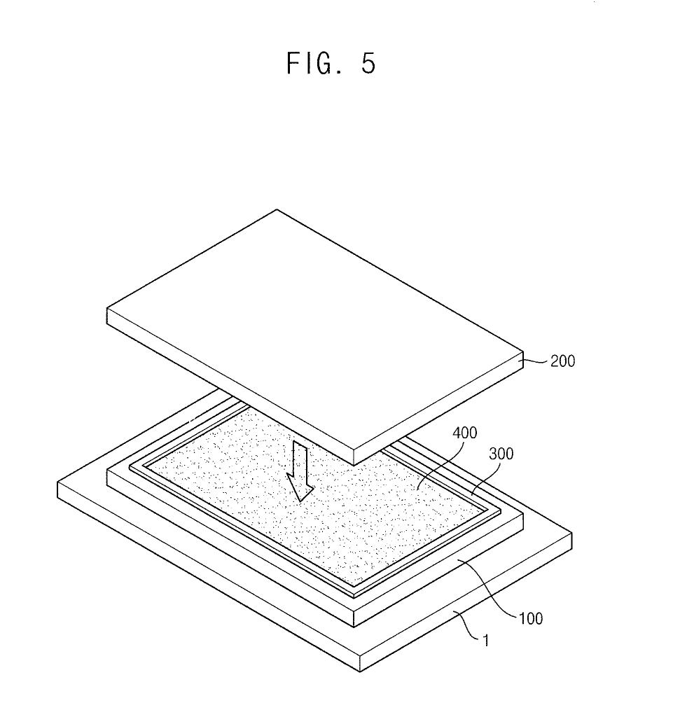

Referring to FIG. 5, a second substrate 200 opposite to the first substrate 100 is disposed on the first substrate 100. A space having the height substantially the same as the sealing pattern 300 is formed between the first substrate 100 and the second substrate 200. The space is filled with the liquid crystal 410 to form the liquid crystal layer 400.

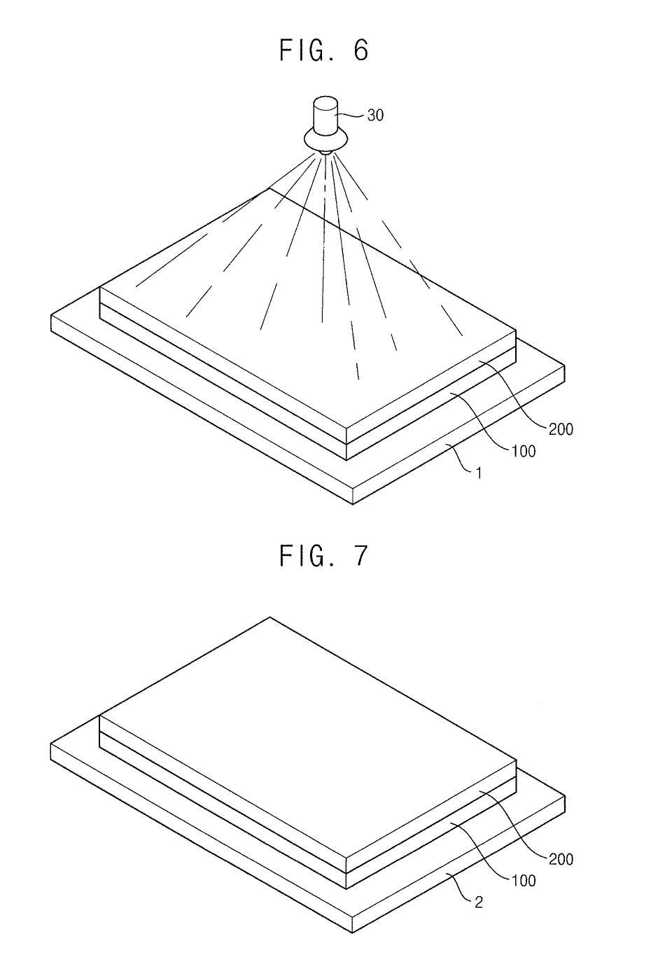

Referring to FIG. 6, a light source 30 is disposed on the second substrate 200. A light such as, for example, UV light provided from the light source 30 is irradiated into the first substrate 100 and the second substrate 200. A photo-curable resin in the sealing pattern 300 reacts with the light to be cured.

Referring to FIG. 7, the first substrate 100 and the second substrate 200 are disposed on a hot plate 2. The first substrate 100 and the second substrate 200 are provided with heat from the hot plate 2. A heat-curable resin in the sealing pattern 300 is cured by heat.

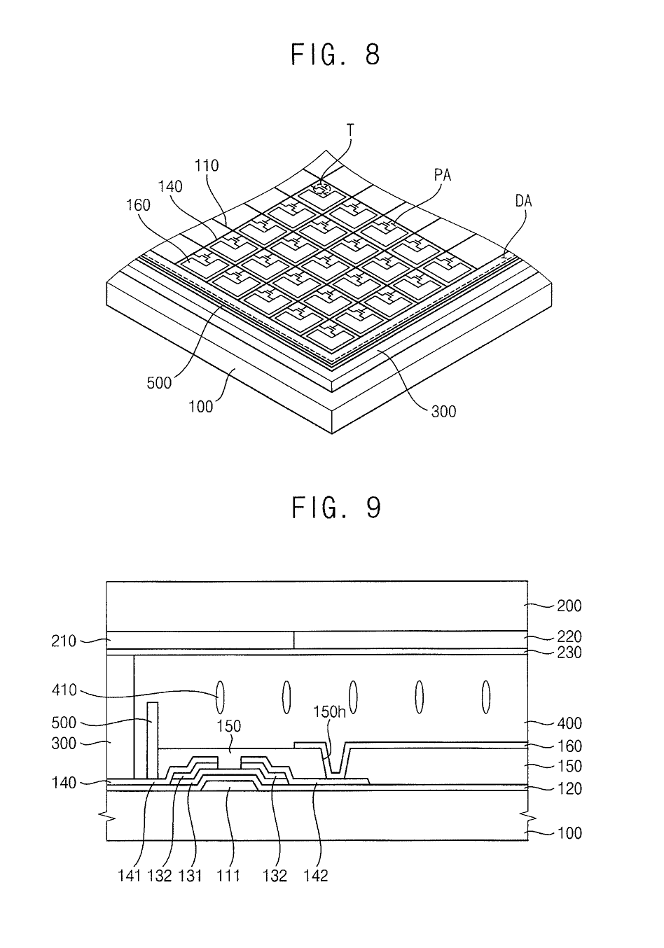

FIG. 8 is a perspective view illustrating a display device according to another example embodiment of the present invention. FIG. 9 is a cross-sectional view illustrating a boundary portion of a display area of the display device shown in FIG. 8.

Referring to FIGS. 8 and 9, a display device includes a first substrate 100, a second substrate 200 opposite to the first substrate 100, a liquid crystal layer 400 interposed between the first substrate 100 and the second substrate 200. A display area DA displaying an image is defined on the first substrate 100. The display area DA includes a center portion of the first substrate 100 excluding a peripheral portion of the first substrate 100.

In an outer area of the display area DA, a sealing pattern 300 is formed along the peripheral portion of the first substrate 100 to combine the first substrate 100 and the second substrate 200 with each other. Alternatively, the sealing pattern 300 may be formed on the second substrate 200 corresponding to the outer area of the display area DA.

A wall member 500 is foamed between the sealing pattern 300 and the display area DA to prevent elution of the sealing pattern 300 into the display area DA. The height of the wall member 500 may be shorter than a height of the sealing pattern 300.

The wall member 500 may be formed on the first substrate 100. Alternatively, the wall member 500 may be formed on the second substrate 200. When the wall member 500 is formed on a substrate having a space member that is formed in the display area DA to remain a space between the first substrate 100 and the second substrate 200, the wall member 500 and the space member may be patterned by an identical process, so that a manufacturing process may be simplified.

The wall member 500 includes a UV curing resin that is included in the space member. The wall member 500 includes, for example, about 15 percent by weight to about 25 percent by weight of an acrylic resin, about 10 percent by weight to about 20 percent by weight of an acrylic monomer, about 1 percent by weight to about 10 percent by weight of a photosensitizer, and about 55 percent by weight to about 65 percent by weight of a solvent.

Having described the exemplary embodiments of the present invention, it is further noted that it is readily apparent to those of reasonable skill in the art that various modifications may be made without departing from the spirit and scope of the invention which is defined by the metes and bounds of the appended claims.

What is claimed is:

1. A sealant for a display device comprising:
a photoinitiator comprising an oxime ester compound represented by the following Chemical Formula 2; and
a curing resin, 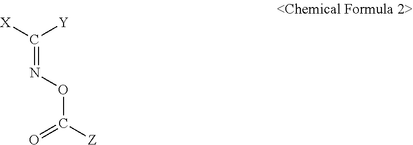
wherein X of the photoinitiator compound comprises one selected from the group consisting of functional groups represented by the following Chemical Formulas 3 to 5. 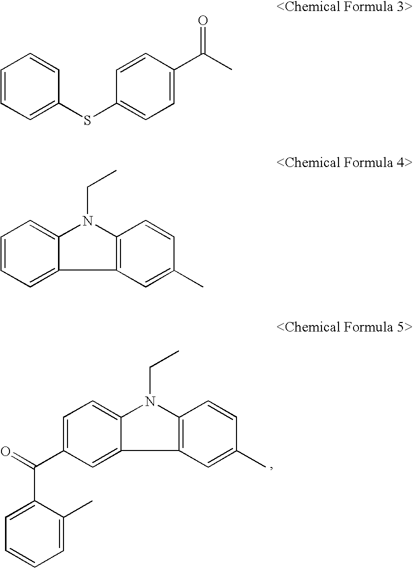
wherein Y of the photoinitiator compound comprises a functional group represented by the following Chemical Formula 6,
CₙH₂ₙ₊₁ <Chemical Formula 6>
wherein n represents an integer in the range of 1 to 12,
wherein Z of the photoinitiator compound comprises one selected from the group consisting of functional groups represented by the following Chemical Formulas 7 and 8. 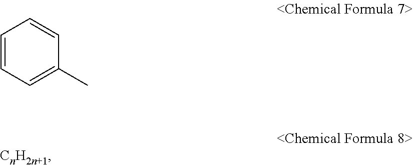
and wherein n represents an integer in the range of 1 to 12.

2. The sealant of claim 1, comprising:
about 0.5 percent by weight to about 2 percent by weight of the photoinitiator.

3. The sealant of claim 2, wherein the photoinitiator has a molecular weight more than 350.

4. The sealant of claim 1, wherein the sealant further comprises a curing agent, a coupling agent and a filler.

5. The sealant of claim 4, wherein the coupling agent comprises a silane compound and wherein the curing resin comprises one of an acrylic compound or an epoxy-based compound.

6. The sealant of claim 5, wherein the coupling agent includes one of a compound selected from the group consisting of 3-glycidoxypropyl trimethoxy silane, 3-glycidoxypropyl methyl dimethoxy silane, 3-methacryloxypropyl trimethoxy silane, 3-chloropropyl methyl dimethoxy silane, and 3-chloropropyl trimethoxy silane.

7. The sealant of claim 4, wherein the filler comprises one of the following selected from the group consisting of silica, silicon carbide, silicon nitride, boron nitride, calcium carbonate, magnesium carbonate, calcium silicate, aluminum silicate, and glass fiber.

8. The sealant of claim 4, wherein the sealant includes about 55 percent by weight to about 65 percent by weight of the curing resin, about 3 percent by weight to about 4 percent by weight of the curing agent, about 0.5 percent by weight to about 2 percent by weight of the photoinitiator, about 0.5 percent by weight to about 2 percent by weight of the coupling agent, and about 20 percent by weight to about 30 percent by weight of the filler.

9. The sealant of claim 1, wherein the photoinitiator of claim 1 has a maximum absorption coefficient at a wavelength of about 365 nm.

10. A sealant for a display device comprising:
a photoinitiator comprising a compound represented by the following Chemical Formula 9; and
a curing resin.

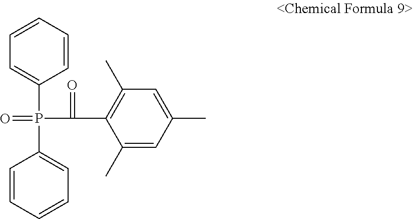

11. A display device comprising:
a first substrate having a display area;
a second substrate opposite to the first substrate;
a liquid crystal layer interposed between the first substrate and the second substrate; and
a sealing pattern contacting the first substrate and the second substrate so as to combine the first substrate and second substrate with each other, and wherein the sealing pattern comprising the photoinitiator of claim 1.

12. The display device of claim 11, wherein the sealing pattern comprises:
about 0.5 percent by weight to about 2 percent by weight of the photoinitiator.

13. The display device of claim 12, wherein the photoinitiator has a molecular weight more than 350.

14. The display device of claim 11, further comprising
a wall member disposed between the display area and the sealing pattern.

15. A display device comprising:
a first substrate having a display area;
a second substrate opposite to the first substrate;
a liquid crystal layer interposed between the first substrate and the second substrate; and
a sealing pattern contacting the first substrate and the second substrate so as to combine the first substrate and the second substrate with each other, and wherein the sealing pattern comprising the photoinitiator of claim 10.

16. The display device of claim 15, further comprising
a wall member disposed between the display area and the sealing pattern.

17. A method of manufacturing the display device, comprising:
coating the sealant of claim 1 along a peripheral portion of a first substrate to form a sealing pattern thereon;
dropping a liquid crystal on the first substrate;
disposing a second substrate which is opposite to the first substrate on the first substrate; and
curing the sealing pattern to combine the first substrate and the second substrate with each other.

18. The method of claim 17, wherein the sealant includes about 55 percent by weight to about 65 percent by weight of the curing resin, about 3 percent by weight to about 4 percent by weight of a curing agent, about 0.5 percent by weight to about 2 percent by weight of the photoinitiator, about 0.5 percent by weight to about 2 percent by weight of a coupling agent, and about 20 percent by weight to about 30 percent by weight of a filler.

19. The method of claim 17, wherein the curing of the sealing pattern includes curing a photo curable resin in the sealant with light to form the curing resin.

20. A method of manufacturing the display device, comprising:
coating the sealant of claim 10 along a peripheral portion of a first substrate to form a sealing pattern thereon;
dropping a liquid crystal on the first substrate;
disposing a second substrate which is opposite to the first substrate on the first substrate; and
curing the sealing pattern to combine the first substrate and the second substrate with each other.

21. The method of claim 20, wherein the sealant includes about 55 percent by weight to about 65 percent by weight of the curing resin, about 3 percent by weight to about 4 percent by weight of a curing agent, about 0.5 percent by weight to about 2 percent by weight of the photoinitiator, about 0.5 percent by weight to about 2 percent by weight of a coupling agent, and about 20 percent by weight to about 30 percent by weight of a filler.

22. The method of claim 20, wherein the curing of the sealing pattern includes curing a heat curable resin in the sealant with heat to form the curing resin.
